(19) United States
(12) Patent Application Publication
(10) Pub. No.: US 2025/0380226 A1
(43) Pub. Date: Dec. 11, 2025

(54) DEVICE TO SATELLITE POWER REDUCTION

(71) Applicant: Apple Inc., Cupertino, CA (US)

(72) Inventors: Lorenzo BERTIZZOLO, San Francisco, CA (US); Prashant H. VASHI, San Jose, CA (US); Ioannis PEFKIANAKIS, San Jose, CA (US)

(21) Appl. No.: 19/217,193

(22) Filed: May 23, 2025

Related U.S. Application Data
(60) Provisional application No. 63/656,933, filed on Jun. 6, 2024.

(51) Int. Cl. H04W 52/36; H04W 52/14; H04W 52/22; H04W 52/24; H04W 52/34; H04W 84/06

(52) U.S. Cl. CPC H04W 52/367; H04W 52/146; H04W 52/225; H04W 52/241; H04W 52/343; H04W 84/06

(57) ABSTRACT

The described embodiments regard methods and apparatus to adapt operating parameters of a wireless device to control device to satellite transmit power for signal transmission to improve performance of data throughput or to reduce messaging latency. A wireless device monitors average uplink transmit power levels and at least one transmit power reduction criterion to determine whether to transmit at a reduced transmit power level, with which more transmit time intervals of a power averaging time period can satisfy a specific absorption rate (SAR) budget, or at an unreduced transmit power level, with which fewer transmit time intervals can satisfy the SAR budget over the power averaging time period.

### CROSS-REFERENCE TO RELATED APPLICATIONS

The present application claims the benefit of U.S. Provisional Application No. 63/656,933, entitled “DEVICE TO SATELLITE POWER REDUCTION,” filed Jun. 6, 2024, the content of which is incorporated by reference herein in its entirety for all purposes.

### FIELD

The described embodiments relate generally to wireless communication, including methods and apparatus to adapt operation of a wireless device to control device to satellite transmit power. A wireless device monitors average uplink transmit power levels and one or more transmit power reduction criterion to determine whether to transmit at a reduced transmit power level, with more transmit time intervals of a power averaging time period satisfying a specific absorption rate (SAR) budget or at an unreduced transmit power level, with fewer transmit time intervals satisfying the SAR budget over the power averaging time period.

### BACKGROUND

Recent technological advances have integrated various wireless radio access technologies (RATs) into single, multi-functional wireless devices. Specialized single-function wireless devices are being replaced and/or supplemented by multi-functional wireless devices that can communicate using the various RATs. Wireless devices that transmit and receive signals via earth orbiting satellites can be used for communication in areas with sparse or negligible cellular wireless coverage. Integrating satellite communication technology into multi-functional wireless devices can increase their usefulness when traveling to remote areas that lack cellular wireless service.

Uplink transmission from a wireless device to a satellite usually operates at a fixed transmit power level to maximize received signal quality at the satellite; however, uplink transmission must also satisfy specific absorption rate (SAR) limits established by communications regulatory agencies. To stay within a mandated SAR budget, the wireless device may need to forgo uplink transmission during some transmit time intervals to ensure the average uplink transmit power level does not exceed the SAR limit. These empty transmit time intervals result in lower throughput for uplink transmission by the wireless device to the satellite.

### SUMMARY

The described embodiments relate generally to wireless communication, including methods and apparatus to adapt operation of a wireless device to control device to satellite transmit power. A wireless device monitors average uplink transmit power levels and one or more transmit power reduction criterion to determine whether to transmit at a reduced transmit power level, with more transmit time intervals of a power averaging time period satisfying a specific absorption rate (SAR) budget or at an unreduced transmit power level, with fewer transmit time intervals satisfying the SAR budget over the power averaging time period.

Methods, devices, and apparatus to adapt operating parameters for satellite signal transmission by a wireless device to improve performance are described herein. The wireless device measures transmit signal power levels and channel characteristics to determine whether to operate in an unreduced transmit power mode or in a reduced transmit power mode. Intelligent transmit power control in the wireless device can monitor power consumption levels to determine whether average power consumption exceeds a threshold percentage of a SAR power budget. When the average power consumption exceeds the SAR budget threshold percentage, the wireless device can monitor additional transmit power reduction criteria to determine whether conditions are satisfied to reduce the uplink transmit power during one or more transmit time intervals. Exemplary transmit power reduction criteria include: i) determining an uplink packet type, e.g., high priority such as an acknowledge (ACK) message or control message that should not be transmitted with lower power or low priority that can be retransmitted if necessary, ii) estimating block error rate (BLER) and/or other uplink channel conditions to assess the quality of the uplink channel from the wireless device to the satellite, iii) measuring downlink channel signal characteristics to ensure the communication channel between the wireless device and the satellite is not blocked, and iv) monitoring a network congestion metric to determine whether the satellite and ground infrastructure network can support additional data traffic. When conditions are satisfied, the wireless device can transmit at a reduced power level, and when conditions are not satisfied, the wireless device can transmit at an unreduced power level. The wireless device can be configured with a fixed amount of transmit power reduction based on offline modeling of the wireless device to satellite channel that accounts for hardware characteristics of the wireless device and of the satellite. The wireless device can also be configured to determine dynamically in the field an amount of transmit power reduction to apply. By transmitting at a reduced power level during more transmit time intervals per time averaging time period than when transmitting at an unreduced power level, the wireless device can increase the uplink data throughput and reduce latency for transmitting messages that span multiple transmit time intervals, while continuing to satisfy SAR limits and staying within a SAR power budget.

Other aspects and advantages of the present disclosure will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an exemplary satellite communication system, in accordance with some embodiments.

FIG. 2 illustrates exemplary diagrams of uplink transmissions with and without dynamic transmit power reduction, in accordance with some embodiments.

FIG. 3 illustrates an example of adjusting transmit power levels based on various power reduction criteria, in accordance with some embodiments.

FIG. 4 illustrates an exemplary method performed by a wireless device to control uplink device to satellite transmit power levels, in accordance with some embodiments.

FIG. 5 illustrates an exemplary apparatus for implementation of embodiments disclosed herein, in accordance with some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments relate generally to wireless communication, including methods and apparatus to adapt operation of a wireless device to control device to satellite transmit power. A wireless device monitors average uplink transmit power levels and transmit power reduction criteria to determine whether to transmit at a reduced transmit power level, with more transmit time intervals of a power averaging time period satisfying a specific absorption rate (SAR) budget or at an unreduced transmit power level, with fewer transmit time intervals satisfying the SAR budget over the power average time period.

Methods, devices, and apparatus to adapt operating parameters for satellite signal transmission by a wireless device to improve performance are described herein. The wireless device measures transmit signal power levels and channel characteristics to determine whether to operate in an unreduced transmit power mode or in a reduced transmit power mode. Intelligent transmit power control in the wireless device can monitor power consumption levels to determine whether average power consumption exceeds a threshold percentage of a SAR power budget. When the wireless device operates below the SAR budget threshold percentage, the wireless device can transmit at an unreduced power level. When the average power consumption exceeds the SAR budge threshold percentage, the wireless device can monitor additional transmit power reduction criteria to determine whether conditions are satisfied to reduce the uplink transmit power during one or more transmit time intervals.

A first exemplary transmit power reduction criterion includes determining an uplink packet type, e.g., a high priority uplink packet that includes an acknowledgement (ACK) message or control message that should not be transmitted with lower power or a low priority uplink packet that can tolerate a lower transmit power and be retransmitted if necessary. A second exemplary transmit power reduction criterion includes estimating an uplink block error rate (BLER) and/or other uplink channel conditions to assess the quality of the uplink channel from the wireless device to the satellite. When the uplink BLER exceeds a BLER threshold the wireless device transmits at an unreduced power level, and when the uplink BLER does not exceed the BLER threshold, the wireless device may transmit at a reduced power level. A third exemplary transmit power reduction criterion includes measuring downlink channel signal characteristics to ensure the communication channel between the wireless device and the satellite is not blocked. Representative downlink channel signal characteristics include a received signal strength indicator (RSSI) value and a received signal-to-noise-ratio (SNR) value, which can provide an indication of whether the communication channel is blocked or the satellite is difficult for the wireless device to reach. When the downlink channel characteristics indicate that the device to satellite channel is blocked or has poor signal strength/quality, the wireless device can transmit at the unreduced power level, and when the downlink channel characteristics indicate that the device to satellite channel is not blocked, the wireless device may transmit at the reduced power level. A fourth exemplary transmit power reduction criterion includes monitoring a network congestion metric to determine whether the satellite and ground infrastructure network can support additional data traffic. In some embodiments, the satellite and ground infrastructure network provides an indication of network congestion levels to the wireless device, and when the satellite and ground infrastructure network is congested, the wireless device can transmit at the unreduced power level. When the satellite and ground infrastructure network is not congested, the wireless device may transmit at the reduced power level.

In some embodiments, when one or more transmit power reduction criteria are satisfied, the wireless device can transmit at a reduced power level. In some embodiments, the wireless device transmits at the reduced power level only when all transmit power reduction criteria are satisfied. In some embodiments, the wireless device transmits at the unreduced power level when at least one transmit power reduction criterion is not satisfied.

The wireless device can be configured with a fixed amount of transmit power reduction based on offline modeling of the wireless device to satellite channel that accounts for hardware characteristics of the wireless device and of the satellite. The offline modeling can estimate uplink performance from the wireless device to the satellite based on i) a device transmitter antenna pattern, ii) a satellite receiver antenna pattern, and iii) a characterization of an uplink channel from the device to the satellite. The offline modeling can provide to the wireless device (e.g., preconfigured via software/firmware in the wireless device) an amount of transmit power reduction to apply, e.g., 1 dB lower transmit power, when transmitting at the lower power level. In some embodiments, the offline modeling provides a table or database of values corresponding to various configurations of the wireless device and/or of the wireless device to satellite communication channel, and the wireless device selects an amount of transmit power reduction to apply based on matching the wireless device and channel characteristics to information in the table or database. In some embodiments, the wireless device is configured to determine dynamically in the field an amount of transmit power reduction to apply while in the field, e.g., using a table lookup and/or performing its own modeling of uplink performance.

By transmitting at a reduced power level, the wireless device can transmit during more transmit time intervals per time averaging time period than when transmitting at an unreduced power level. As such, the wireless device can increase the uplink data throughput and reduce latency for transmitting messages that span multiple transmit time intervals by applying transmit power reduction intelligently based on existing channel conditions, network status, data packet type, device configuration, and the like.

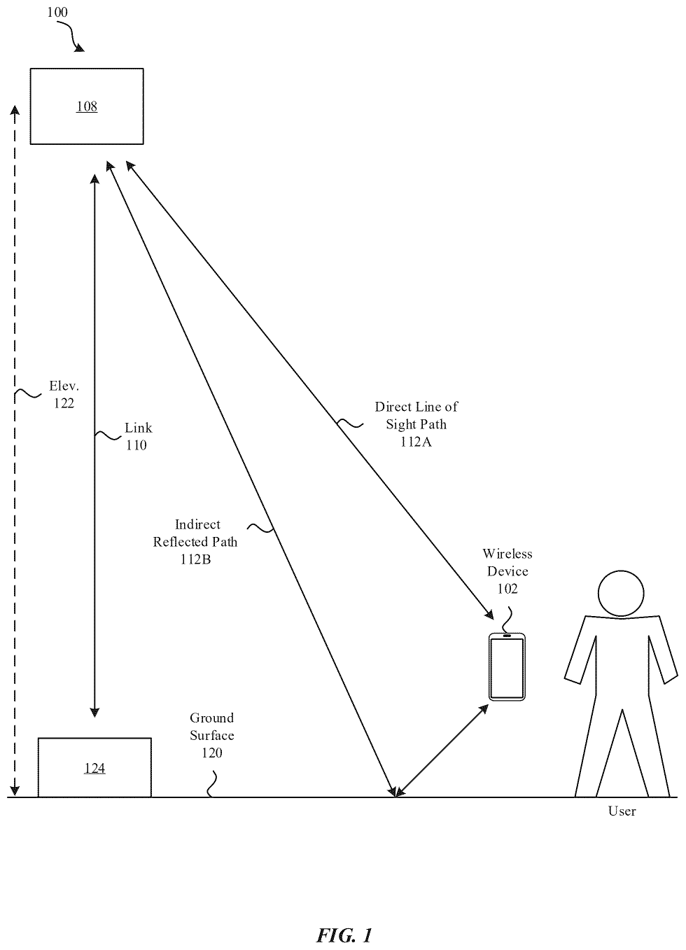

These and other embodiments are discussed below with reference to FIGS. 1-5; however, those skilled in the art will readily appreciate that the detailed description given herein with respect to these figures is for explanatory purposes only and should not be construed as limiting.

FIG. 1 illustrates a diagram 100 of a communication system including a satellite 108 in communication with a wireless device 102 and a ground station 124. The satellite 108 communicates bi-directionally with the ground station 124 via a ground station to satellite communication link 110. The wireless device 102 receives downlink signals from the ground station 124 via the satellite 108 over a direct line of sight path 112A. The wireless device 102 can also receive downlink signals via one or more indirect paths, e.g., an indirect reflected path 112B, that reflects off of a surface, e.g., the surrounding ground surface 120, a building, etc. As the downlink signals received by the wireless device 102 via the indirect reflected path 112B travel a longer distance to the wireless device 102 than the downlink signals received by the wireless device 102 via the direct line of sight path 112A, the two downlink signals combine at the wireless device 102 with a phase delay due to their time differences in traveling to the wireless device 102, which causes an impairment known as multipath. Depending on the wavelength of the carrier frequency used by the satellite 108 for the downlink signals and the amount of phase delay, the combined downlink signal received by the wireless device 102 can include constructive multi-path interference, resulting in a higher received signal level, or destructive multi-path interference, resulting in a lower received signal level.

The wireless device 102 also transmits uplink signals to the ground station 124 via the satellite 108, and the satellite 108 relays the uplink signals to the ground station 124 via the ground station to satellite communication link 110. The uplink signals received at the satellite 108 can also include both a direct line of sight path component and one or more indirect path components, resulting in multi-path interference in the uplink signals received at the satellite 108 similar to that encountered by the wireless device 102 for downlink signals received from the satellite 108. The performance of uplink communication from the wireless device 102 to the satellite 108 can further depend on positioning (orientation, movement) of the wireless device 102, the elevation 122 of the satellite 108, the directionality of transmit antennas of the wireless device 102, an amount of uplink multi-path interference, an amount of signal blockage and/or shadowing that interfere with uplink transmissions, and the like. When signal communication between the wireless device 102 and the satellite 108 is poor, the wireless device 102 can transmit at an unreduced power level to maximize signal quality at a receiver of the satellite 108. The wireless device 102 can also be required to satisfy specific absorption rate (SAR) constraints mandated by governmental regulatory agencies, e.g., the Federal Communications Commission (FCC) in the United States, to limit cumulative exposure to radiated wireless signals transmitted by the wireless device 102 over a power averaging time period.

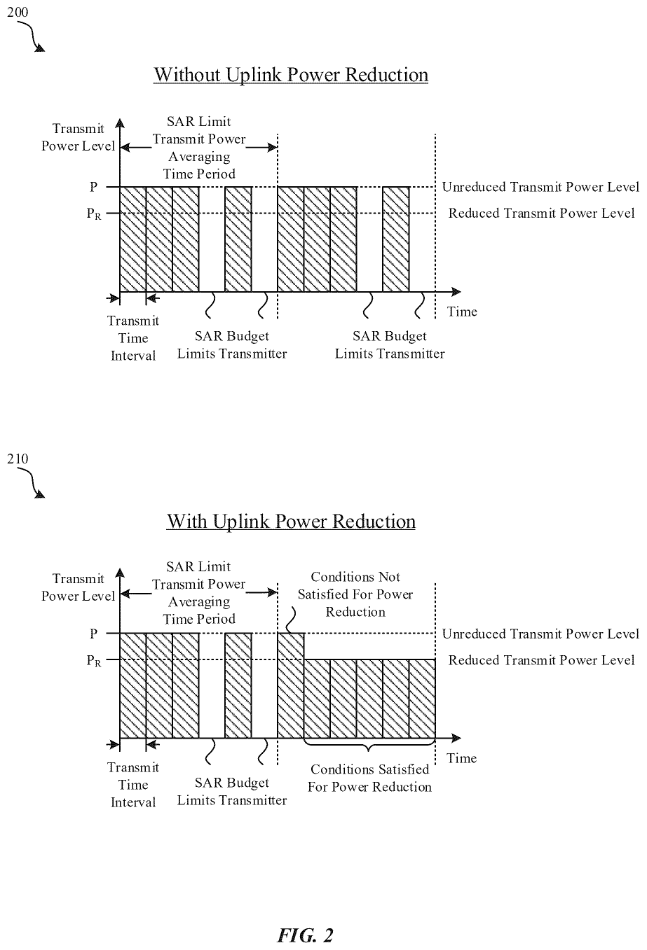

FIG. 2 illustrates a diagram 200 of an example of uplink communication from a wireless device 102 to a satellite 108. Transmission time can be divided into transmit time intervals during which the wireless device 102 transmits or refrains from transmitting. In addition, a limitation on SAR exposure to radiated wireless signals, e.g., mandated by a governmental agency, can restrict the total amount of transmit power that the wireless device 102 can transmit during a transmit power averaging time period. In the example of diagram 200, the wireless device 102 can transmit at an unreduced transmit power level P, up to a maximum of four transmit time intervals during one transmit power averaging time period that spans six consecutive transmit time intervals. The wireless device 102 can be configured to use the unreduced transmit power level P when conditions to apply power reduction and use a reduced transmit power level P_{R} are not satisfied. In some embodiments, the wireless device 102 monitors average transmit power levels over one or more previous transmit time intervals to determine whether transmission is allowed during one or more present or forthcoming transmit time intervals. In some embodiments, the wireless device 102 measures average transmit power levels using a sliding window spanning a transmit power averaging time period. In the example of diagram 200, the wireless device 102 transmits for no more than four transmit time intervals during any set of six consecutive time intervals. The limitation imposed by satisfying SAR constraints, also referred to as meeting a SAR power budget, requires the wireless device 102 to refrain from transmitting during a number of transmit time intervals, which includes when the wireless device 102 has pending uplink data messages to transmit to the satellite 108. The wireless device 102 may use the unreduced transmit power level P, which does not allow for continuous transmission during every transmit time interval in order to meet the SAR power budget, because individual transmissions at the unreduced transmit power level P will be received at the satellite 108 with a higher signal strength and/or signal quality, thereby improving uplink transmission reliability. The silent transmit time intervals imposed by the wireless device 102 to satisfy the SAR power budget, however, can decrease the total uplink data throughput (as silent transmit time intervals provide no data throughput) and can increase uplink latency for messages that span multiple transmit time intervals. When the wireless device can reduce the uplink transmit power level and communicate the same amount of data within a transmit time interval, the amount of uplink data throughput can increase and the amount of latency decrease, while still remaining within the SAR power budget. Decreasing the transmit power level increases the chance of received signals at the satellite 108 being corrupted, and therefore the wireless device 102 can monitor one or more transmit power reduction criteria to determine whether a reduced transmit power level can be used.

FIG. 2 further illustrates a diagram 210 of an example of uplink communication from a wireless device 102 to a satellite 108 with uplink power reduction, i.e., one or more transmit time intervals during which the wireless device 102 transmits at the reduced transmit power level P_{R} when certain conditions are satisfied, e.g., when one or more transmit power reduction criteria are satisfied. By transmitting at a reduced transmit power level, the wireless device 102 can transmit during more transmit time intervals of a transmit power averaging time period while continuing to meet a SAR power budget. For example, in the leftmost transmit power averaging time period, the wireless device 102 can transmit during only four transmit time intervals and must refrain from transmitting during two other time intervals to ensure that the SAR power budget is met; however, in the rightmost transmit power averaging time period, the wireless device 102 transmits during all six transmit time intervals, using a reduced transmit power level P_{R} during five of the transmit time intervals. Transmitting during the two additional time intervals allows the wireless device 102 to increase the uplink data throughput. The wireless device 102 only transmits with reduced transmit power levels when power reduction conditions (e.g., one or more transmit power reduction criteria) are satisfied. Otherwise, the wireless device 102 transmits at the unreduced transmit power level, or refrains from transmitting, during transmit time intervals when the power reduction conditions (one or more transmit power reduction criteria) are not satisfied.

Intelligent power control can be applied to reduce transmit power levels of the wireless device 102 based on one or more transmit power reduction criteria in real-time, with goal of the wireless device 102 using the transmit power budget available within SAR limits more opportunistically. The transmit power budget of a wireless device 102 is mandated by regulatory agencies and can be expressed as a limit on the average transmit power P_{AVG} over a transmit power averaging time period T. The average transmit power P_{AVG} over any transmit power averaging time period of length T is required to satisfy the mandated SAR limit. In a given radio access technology (RAT), e.g., 4G LTE or 5G, the mandated SAR limit results in a maximum total amount of transmit time T_{TX} at a given transmit power level P during the transmit power averaging time period T. Based on power reduction conditions (e.g., one or more transmit power reduction criteria) that are specific to the wireless device 102, to the satellite 108, and to the satellite infrastructure network, dynamic transmit power control at the wireless device 102 can be applied in real-time to increase the amount of transmission time Trx of a transmit power averaging time period T during which the wireless device 102 can transmit, thereby improving the performance of the uplink between the wireless device 102 and the satellite 108.

Exemplary power reduction conditions include: i) transmit power budget utilization (e.g., when the wireless device 102 is transmitting well below the maximum total power budget available to satisfy SAR constraints, the uplink throughput may not need to be increased), ii) transmit packet type (e.g., select critical priority uplink messages, such as acknowledgement (ACK) or a control signaling message may require higher signal-to-noise-ratio reception to reduce the probability of significant communication errors), iii) wireless device 102 to satellite 108 uplink performance (e.g., uplink block error rate, BLER) may indicate that higher transmit signal power is required, iv) satellite 108 to wireless device 102 downlink performance (e.g., a received signal strength indicator (RSSI) value and/or a received signal quality value, such as an SNR value, may indicate channel conditions, such as blockage, shadowing, or multi-path, that may affect uplink performance), and v) network congestion (which can indicate whether the satellite and its associated ground infrastructure can support higher data throughput by the wireless device 102).

A wireless device 102 to satellite 108 uplink operating with a fixed transmit power level P can transmit data messages divided into individual packets that each span a transmit time interval T_{PACKET}. In accordance with satisfying the SAR power budget over a given transmit power averaging time period T, the wireless device 102 to satellite 108 uplink with an unreduced transmit power level P can at most support N packets, where N=(P_{AVG}·T)/(T_{PACKET}·P). When intelligent transmit power control is applied to the wireless device 102 to satellite 108 uplink, one or more of the packets may be transmitted during the transmit power averaging time period T at a reduced transmit power level P_{R}, which may increase the total number of packets that can be transmitted in the transmit power averaging time period T. If all packets in the transmit power averaging time period T are transmitted at the reduced transmit power level P_{R}, then the maximum number of packets that may be transmitted is N_{R}=(P_{AVG}·T)/(T_{PACKET}·P_{R}), where N_{R}≥N. The wireless device 102 can use intelligent transmit power control to increase the data throughput of the wireless device 102 to satellite 108 uplink while continuing to satisfy the SAR power budget constraints.

The wireless device 102 can monitor one or more transmit power reduction criteria to determine whether to apply transmit power reduction. The wireless device 102 may apply transmit power reduction only when expected to provide improved data throughput performance or reduced messaging latency. Specific conditions to determine whether to apply transmit power reduction can include the following. The wireless device 102 can monitor how much of the transmit power budget is being consumed to determine whether the wireless device 102 is operating with a high transmit power budget utilization that exceeds a transmit power budget threshold, e.g., more than 50%. Transmitting at the unreduced transmit power level P can be preferred to increase the probability of correct reception of the uplink transmissions at the satellite 108. When uplink transmissions of the wireless device 102 are not constrained by the SAR power budget, i.e., the wireless device 102 can transmit during more transmit time intervals as needed without exceeding the SAR power budget. When the wireless device 102 is transmitting more frequently at the unreduced transmit power level P, i.e., transmitting during more transmit time intervals per transmit power averaging time period, there is a higher probability that the wireless device 102 may be limited by the SAR power budget constraints. The transmit power budget consumption PB_{CONSUMED} of the wireless device 102 can be calculated as PB_{CONSUMED}=P_{TX}/P_{AVG}, where P_{TX} is the average transmit power by the wireless device 102 during the most recent transmit averaging time period TX. When PB_{CONSUMED} exceeds a power budget consumption threshold, the wireless device 102 can determine whether to transmit at a reduced transmit power level P_{R} instead of at the unreduced transmit power level P for one or more subsequent transmit time intervals based on whether one or more additional transmit power reduction criteria are satisfied.

The wireless device 102 can restrict use of transmit power reduction to certain transmit packet types, e.g., to allow transmit power reduction for transmit packets that have lower priority, can sustain lower latency, and/or can be lost or corrupted and require retransmission without causing significant communication issues, e.g., low priority unicast packets. The wireless device 102 can disallow transmit power reduction for transmit packets that have higher priority or have critical functions, such as acknowledgement (ACK) messages or control signaling messages. The wireless device 102 can thereby preserve higher SNR for higher priority messages by transmitting at the unreduced transmit power level P, while allowing for lower priority messages to be transmitted at a reduced transmit power level P_{R}. The wireless device 102 can monitor uplink channel conditions, e.g., a wireless device 102 to satellite 108 channel metric such as an uplink block error rate (BLER) and allow reduced transmit power level transmissions only when the uplink BLER does not exceed a BLER threshold. The wireless device 102 does not want to risk aggravating uplink performance when the uplink BLER level already exceeds the BLER threshold. In some embodiments, the wireless device 102 monitors ACK messages received from the satellite 108 responsive to uplink transmissions to estimate the uplink BLER, where unacknowledged messages can be considered lost or corrupted and require re-transmission. The wireless device 102 can also monitor downlink channel conditions, e.g., a satellite 108 to wireless device 102 channel metric such as a received signal strength indicator (RSSI) value and/or a signal-to-noise-ratio (SNR) value, to determine whether there is good channel conditions between the wireless device 102 and the satellite 108. The downlink channel metrics can provide an indication about whether the satellite is blocked from direct view by the wireless device 102, whether there is significant interference from shadowing or multi-path, and the like. The wireless device 102 can be configured to not use reduced transmit power levels when operating in blockage scenarios, as the uplink channel can be similarly impaired for the wireless device 102. In some embodiments, the wireless device 102 can require that one or more downlink channel metrics, such as the RSSI value and/or the SNR value, satisfy corresponding threshold values. The wireless device 102 can further monitor network conditions of the satellite and associated ground infrastructure network to ascertain whether higher data traffic throughput by the wireless device 102 in the uplink direction from the wireless device 102 to the satellite 108 and back down through the ground infrastructure can be supported. In some embodiments, the satellite 108 and ground infrastructure network can provide an indication of network congestion, and the wireless device 102 can allow uplink transmissions with reduced transmit power levels only when network congestion does not exceed a threshold (or when there is an indication of no network congestion).

When reducing the transmit power level of the uplink signal sent from the wireless device 102 to the satellite 108, the wireless device 102 can determine an amount of power reduction, i.e., a difference between the unreduced transmit power level P and the reduced transmit power level P_{R}, to apply. As discussed previously, the wireless device 102 can transmit at the reduced transmit power level P_{R} when certain transmit power reduction conditions are satisfied. The wireless device 102 can also determine how much transmit power reduction to use. In some embodiments, the amount of transmit power reduction to be used can be determined offline based on a simulation of the wireless device 102 to satellite 108 uplink communication channel. The amount of transmit power reduction to apply can be selected to guarantee that signal quality, e.g., SNR values for signals received at the satellite 108 from the wireless device 102, will result in satisfactory packet error rates. In some embodiments, an offline simulation model of the wireless device 102 to satellite 108 uplink can determine a minimum reduced transmit power level P_{R} (or an amount of transmit power reduction to apply) that achieves a target signal quality, e.g., SNR value, for signals transmitted by the wireless device 102 to the satellite at the reduced transmit power level P_{R}. The offline modeling can account for hardware characteristics of the wireless device 102 and of the satellite 108. The offline modeling can estimate uplink performance from the wireless device to the satellite based on i) a device transmitter antenna pattern, ii) a satellite receiver antenna pattern, and iii) a characterization of an uplink channel from the device to the satellite. The uplink channel can be characterized based on: i) a wireless device 102 to satellite 108 path loss measurement (or estimate), ii) an amount of shadowing, blockage, and/or handgrip impairments affecting the uplink channel, iii) an amount of Doppler impairments due to mobility of the satellite 108 in orbit (for non-stationary satellites), and/or iv) a measurement or estimate of multipath. In some embodiments, the wireless device 102 is configured with a fixed amount of transmit power reduction, determined by offline simulation modeling, to apply, e.g., 1 dB lower transmit power reduction. In some embodiments, the wireless device 102 is configured to select dynamically an appropriate amount of transmit power reduction to apply based on conditions observed by the wireless device 102. In some embodiments, the wireless device 102 is configured with a table or database of values corresponding to various configurations of the wireless device 102 and/or of the wireless device 102 to satellite 108 communication channel, and the wireless device 102 selects an amount of transmit power reduction to apply based on matching the wireless device 102 and channel characteristics to information in the table or database. In some embodiments, the wireless device 102 is configured to determine dynamically in the field an amount of transmit power reduction to apply while in the field, e.g., using a table lookup and/or performing its own modeling of uplink performance.

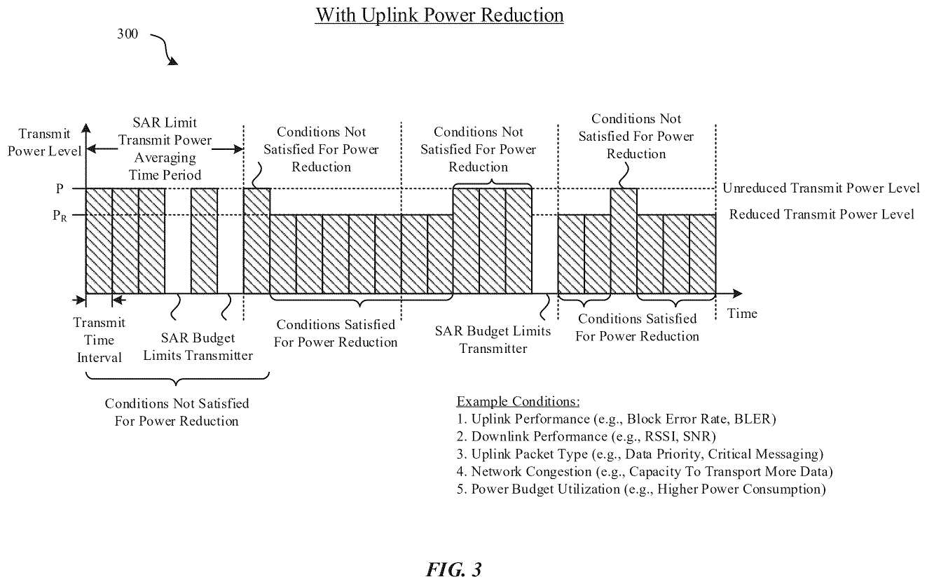

FIG. 3 illustrates a diagram 300 of an example of adaptive uplink transmit power reduction by a wireless device 102. When conditions for transmit power reduction are not satisfied, the wireless device 102 can transmit at an unreduced transmit power level P (or refrain from transmitting if needed to satisfy SAR budget limitations or when there is no uplink data to transmit) during a transmit time interval. When conditions for transmit power reduction are satisfied, the wireless device 102 can transmit at a reduced transmit power level P_{R}. Exemplary transmit power reduction conditions include: i) uplink performance, e.g., a BLER value, ii) downlink performance, e.g., an RSSI and/or an SNR value, iii) uplink packet type, e.g., priority level, critical data or signaling, acknowledgment message, etc., iv) network performance, e.g., capacity to transport additional data throughput, and v) transmit power budget utilization, e.g., at a higher power consumption level. In some embodiments, the wireless device 102 allows for transmission at the reduced transmit power level P_{R} only when all transmit power reduction conditions are satisfied. In some embodiments, the wireless device 102 disallows transmission at the reduced transmit power level P_{R} when at least one transmit power reduction condition is not satisfied.

By adapting the transmit power level and accounting for uplink performance and satellite network conditions, the wireless device 102 can transmit more data packets per time unit (as more transmit time intervals may be used for transmission when transmit power reduction conditions are satisfied). Additionally, the wireless device 102 can transmit data packets with a lower application layer latency, as an application message may require multiple data packets to be transmitted, and the application message may be less restricted by empty transmit time intervals required to satisfy SAR budget limitations.

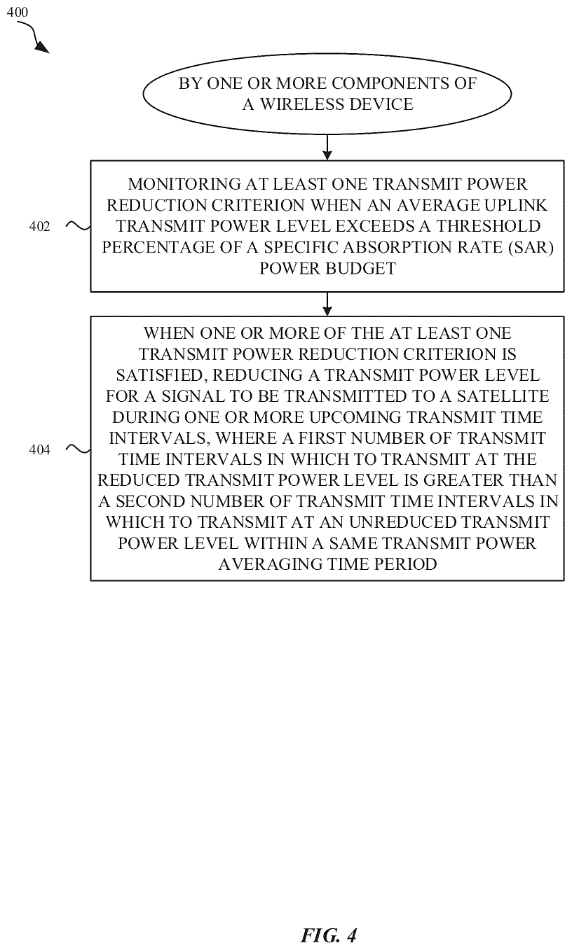

FIG. 4 illustrates a flowchart 400 of an exemplary method to control wireless device to satellite transmit power by a wireless device 102. At 402, one of more components of the wireless device 102 monitor at least one power reduction criterion, when an average uplink transmit power level exceeds a threshold percentage of a specific absorption rate (SAR) power budget. At 404, when one or more the at least one transmit power reduction criterion is satisfied, the one of more components of the wireless device 102 reduce a transmit power level for a signal to be transmitted to a satellite 108 during one or more upcoming transmit time intervals, where a first number of transmit time intervals in which to transmit at the reduced transmit power level is greater than a second number of transmit time intervals in which to transmit at an unreduced transmit power level with a same transmit power averaging time period.

In some embodiments: i) the at least one transmit power reduction criterion includes a plurality of transmit power reduction criteria, and ii) the one or more of the at least one transmit power reduction criterion is not satisfied when one or more transmit power reduction criterion in the plurality of transmit power reduction criteria is not satisfied. In some embodiments, all transmit power reduction criteria must be satisfied in order to reduce the transmit power level of the signal transmitted during the one or more upcoming transmit time intervals. In some embodiments, the at least one transmit power reduction criterion includes one or more of: i) an uplink packet type, ii) an uplink block error rate (BLER), iii) a downlink channel metric, and/or iv) a network congestion metric. In some embodiments, the one or more of the at least one transmit power reduction criterion is satisfied when: i) the uplink packet type is low priority, ii) the uplink BLER does not exceed a BLER threshold, iii) the downlink channel metric indicates a wireless device 102 to satellite 108 uplink channel satisfies a performance threshold, and/or iv) the network congestion metric indicates a satellite and ground infrastructure network can support additional data traffic. In some embodiments, the one of more components of the wireless device 102 are configured to estimate the uplink BLER based on reception of acknowledgement (ACK) messages from the satellite 108 responsive to uplink transmissions from the wireless device 102 to the satellite 108. In some embodiments, the one of more components of the wireless device 102 are configured to estimate the downlink channel metric based on a received signal strength indicator (RSSI) value and/or a signal-to-noise-ratio (SNR) value for communication from the satellite 108. In some embodiments, the satellite and ground infrastructure network indicates a level of network congestion. In some embodiments, a difference between the unreduced transmit power level and the reduced transmit power level is a fixed, predetermined value based on a wireless device 102 to satellite 108 link model. In some embodiments, the wireless device 102 to satellite 108 link model includes: i) a wireless device 102 transmitter antenna pattern, ii) a satellite 108 receiver antenna pattern, iii) a wireless device 102 to satellite 108 path loss, iv) an uplink signal blockage, and v) a multipath effect. In some embodiments, the wireless device 102 is further configured to determine the reduced transmit power level based on i) a wireless device 102 transmitter antenna pattern, ii) a satellite 108 receiver antenna pattern, and iii) a characterization of an uplink channel from the wireless device 102 to the satellite 108. In some embodiments, the at least transmit reduction criteria are not satisfied when an uplink transmission comprises an acknowledgement (ACK) message or a control message.

### Representative Device

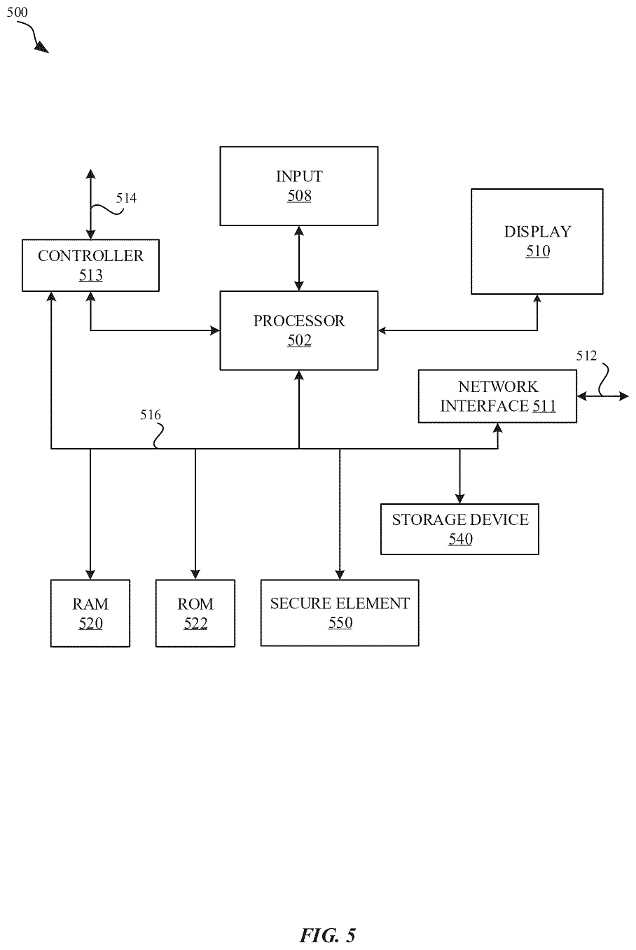

FIG. 5 illustrates a detailed view of a representative computing device 500 that can be used to implement various methods described herein, according to some embodiments. In particular, the detailed view illustrates various components that can be included in the wireless device 102. As shown in FIG. 5, the computing device 500 can include a processor 502 that represents a microprocessor or controller for controlling the overall operation of computing device 500. The computing device 500 can also include a user input device 508 that allows a user of the computing device 500 to interact with the computing device 500. For example, the user input device 508 can take a variety of forms, such as a button, keypad, dial, touch screen, audio input interface, visual/image capture input interface, input in the form of sensor data, etc. Still further, the computing device 500 can include a display 510 that can be controlled by the processor 502 to display information to the user. A data bus 516 can facilitate data transfer between at least a storage device 540, the processor 502, and a controller 513. The controller 513 can be used to interface with and control different equipment through an equipment control bus 514. The computing device 500 can also include a network/bus interface 511 that communicatively couples to a data link 512. In the case of a wireless connection, the network/bus interface 511 can include a wireless transceiver.

The computing device 500 also includes a storage device 540, which can include a single disk or a plurality of disks (e.g., hard drives), and includes a storage management module that manages one or more partitions within the storage device 540. In some embodiments, storage device 540 can include flash memory, semiconductor (solid state) memory or the like. The computing device 500 can also include a Random Access Memory (RAM) 520 and a Read-Only Memory (ROM) 522. The ROM 522 can store programs, utilities or processes to be executed in a non-volatile manner. The RAM 520 can provide volatile data storage, and stores instructions related to the operation of the computing device 500. The computing device 500 can further include a secure element (SE) 550, which can represent secure storage for cellular wireless access control clients, such as a subscriber identity module (SIM) or electronic SIM, for use by the wireless device 102 to establish a wireless wide area network, or to access a satellite communication network.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or fifth generation (5G) or other present or future next generation (NG) developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the wireless devices described herein may be configured as multi-mode wireless communication devices that are also capable of communicating via different third generation (3G) and/or second generation (2G) RATs. In these scenarios, a multi-mode wireless device can be configured to prefer attachment to LTE networks offering faster data rate throughput, as compared to other 3G legacy networks offering lower data rate throughputs. For instance, in some implementations, a multi-mode wireless device may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to control transmit power from a wireless device to a satellite, the method comprising:
by one or more components of the wireless device:
monitoring at least one transmit power reduction criterion when an average uplink transmit power level exceeds a threshold percentage of a specific absorption rate (SAR) power budget; and
when one or more of the at least one transmit power reduction criterion is satisfied, reducing a transmit power level for a signal to be transmitted to the satellite during one or more upcoming transmit time intervals,
wherein a first number of transmit time intervals in which to transmit at the reduced transmit power level is greater than a second number of transmit time intervals in which to transmit at an unreduced transmit power level within a same transmit power averaging time period.

2. The method of claim 1, wherein:
the at least one transmit power reduction criterion comprises a plurality of transmit power reduction criteria; and
the one or more of the at least one transmit power reduction criterion is not satisfied when one or more transmit power reduction criterion in the plurality of transmit power reduction criteria is not satisfied.

3. The method of claim 1, wherein the transmit power reduction criterion comprises one or more of:
an uplink packet type;
an uplink block error rate (BLER);
a downlink channel metric; and/or
a network congestion metric.

4. The method of claim 3, wherein the one or more of the at least one transmit power reduction criterion is satisfied when:
the uplink packet type is low priority;
the uplink BLER does not exceed a BLER threshold;
the downlink channel metric indicates a wireless device to satellite uplink channel satisfies a performance threshold; and/or
the network congestion metric indicates a satellite and ground infrastructure network can support additional data traffic.

5. The method of claim 4, further comprising:
estimating the uplink BLER based on reception of acknowledgement (ACK) messages from the satellite responsive to uplink transmissions from the wireless device to the satellite.

6. The method of claim 4, further comprising:
estimating the downlink channel metric based on a received signal strength indicator (RSSI) value and/or a signal-to-noise-ratio (SNR) value for communication from the satellite.

7. The method of claim 4, wherein the satellite and ground infrastructure network indicates a level of network congestion.

8. The method of claim 1, wherein a difference between the unreduced transmit power level and the reduced transmit power level is a fixed, predetermined value based on a wireless device to satellite link model.

9. The method of claim 8, wherein the wireless device to satellite link model comprises:
a wireless device transmitter antenna pattern;
a satellite receiver antenna pattern;
a wireless device to satellite path loss;
an uplink signal blockage; and
a multipath effect.

10. The method of claim 1, further comprising:
determining the reduced transmit power level based on i) a wireless device transmitter antenna pattern, ii) a satellite receiver antenna pattern, and iii) a characterization of an uplink channel from the wireless device to the satellite.

11. The method of claim 1, wherein the at least one transmit power reduction criterion is not satisfied when an uplink transmission comprises an acknowledgement (ACK) message or a control message.

12. An apparatus comprising:
processing circuitry communicatively coupled to a memory that stores instructions, the processing circuitry configured to:
monitor at least one transmit power reduction criterion when an average uplink transmit power level exceeds a threshold percentage of a specific absorption rate (SAR) power budget; and
when one or more of the at least one transmit power reduction criterion is satisfied, reduce a transmit power level for a signal to be transmitted to a satellite during one or more upcoming transmit time intervals,
wherein a first number of transmit time intervals in which to transmit at the reduced transmit power level is greater than a second number of transmit time intervals in which to transmit at an unreduced transmit power level within a same transmit power averaging time period.

13. The apparatus of claim 12, wherein the transmit power reduction criterion comprises one or more of:
an uplink packet type;
an uplink block error rate (BLER);
a downlink channel metric; and/or
a network congestion metric.

14. The apparatus of claim 13, wherein the one or more of the at least one transmit power reduction criterion is satisfied when:
the uplink packet type is low priority;
the uplink BLER does not exceed a BLER threshold;
the downlink channel metric indicates a wireless device to satellite channel satisfies a performance threshold; and
the network congestion metric indicates a satellite and ground infrastructure network can support additional data traffic.

15. The apparatus of claim 14, wherein the processing circuitry is configured to estimate the uplink BLER based on reception of acknowledgement (ACK) messages from the satellite responsive to uplink transmissions to the satellite.

16. The apparatus of claim 14, wherein the processing circuitry is configured to estimate the downlink channel metric based on a received signal strength indicator (RSSI) value and/or a signal-to-noise-ratio (SNR) value for communication from the satellite.

17. The apparatus of claim 14, wherein the satellite and ground infrastructure network indicates a level of network congestion.

18. The apparatus of claim 12, wherein:
a difference between the unreduced transmit power level and the reduced transmit power level is a fixed, predetermined value based on a wireless device to satellite link model; and
the wireless device to satellite link model comprises:
a wireless device transmitter antenna pattern;
a satellite receiver antenna pattern;
a wireless device to satellite path loss;
an uplink signal blockage; and
a multipath effect.

19. The apparatus of claim 12, wherein the processing circuitry is further configured to determine the reduced transmit power level based on i) a wireless device transmitter antenna pattern, ii) a satellite receiver antenna pattern, and iii) a characterization of an uplink channel from a wireless device to the satellite.

20. A non-transitory computer-readable medium storing instructions for controlling transmit power from a wireless device to a satellite, the instructions comprising:
instructions for monitoring at least one transmit power reduction criterion when an average uplink transmit power level exceeds a threshold percentage of a specific absorption rate (SAR) power budget; and
instructions for, when one or more of the at least one transmit power reduction criterion is satisfied, reducing a transmit power level for a signal to be transmitted to the satellite during one or more upcoming transmit time intervals,
wherein a first number of transmit time intervals in which to transmit at the reduced transmit power level is greater than a second number of transmit time intervals in which to transmit at an unreduced transmit power level within a same transmit power averaging time period.
